(19) United States
(12) Patent Application Publication
(10) Pub. No.: US 2016/0162567 A1
(43) Pub. Date: Jun. 9, 2016

(54) ORGANIZATION AND RETRIEVAL OF INFORMATION ITEMS

(71) Applicant: TELEFONAKTIEBOLAGET L M ERICSSON (PUBL), Stockholm (SE)

(72) Inventors: Hjalmar OLSSON, Bromma (SE); Cristian NORLIN, Stockholm (SE); Marcus NYBERG, Hägersten (SE)

(21) Appl. No.: 14/903,420

(22) PCT Filed: Jul. 9, 2013
(86) PCT No.: PCT/SE2013/050883

§ 371 Date: Jan. 7, 2016

(51) Int. Cl. G06F 17/30; H04L 29/08

(52) U.S. Cl. CPC G06F 17/30598; H04L 67/142; G06F 17/30867; G06F 17/30528; G06F 17/3043

(57) ABSTRACT

There is provided organization of information items of a communication session between communication devices. A session tag of a session is acquired. The session has a duration in time and is associated with a context parameter. The session is monitored. During the duration of the session a plurality of information sources associated with the session are identified. During the duration of the session information items are acquired from the plurality of information sources. The information items are associated with the context parameter. During the duration of the session the information items are linked to the session and at least one of at least one other session, at least one other tagged or untagged information item, and at least one other session tag. There is also provided corresponding retrieval of such information items of a session.

### TECHNICAL FIELD

Embodiments presented herein relate to organization and retrieval of information items, and particularly to a method, a user equipment, a computer program, and a computer program product for organization and retrieval of information items of a session.

### BACKGROUND

In communications systems, there is always a challenge to obtain good performance and capacity for a given communications protocol, its parameters and the physical environment in which the communications system is deployed.

It is envisaged that the amount of data generated and acquired by electronic devices in the communications system will increase. This data will hereinafter be denoted as information items.

One issue that thus may arise in the communications system is how to organize the information items generated and acquired by electronic devices. Speech to text systems and metadata tagging of data is as such known in the art. Although there exists mechanisms for tagging information items (such as geo-tagging and user tagging), it may still be cumbersome to handle large amounts of information items in an efficient manner. One situation where it may be challenging to achieve organization of information items is where there are many sources of information.

Further, mechanisms like Siri may be regarded as a type of intelligent personal assistant and knowledge navigator. Siri works as an application for Apple Inc.'s iOS. The Siri application uses a natural language user interface to answer questions, make recommendations, and perform actions by delegating requests to a set of Web services. However, mechanisms like Siri may only enable isolated searches.

Hence, there is still a need for an improved organization and retrieval of information items.

### SUMMARY

An object of embodiments herein is to provide improved organization and retrieval of information items.

The inventors of the enclosed embodiments have realized that when breaking up the link between time and location of tagged information items, the information items relations between the information items may be lost. The inventors of the enclosed embodiments have realized that one way to provide improved organization and retrieval of information items is therefore to efficiently monitor a session associated with the information items.

A particular object is therefore to provide improved organization and retrieval of information items of a session.

According to a first aspect there is presented a method for organizing information items of a session. The method is performed by a server. The method comprises acquiring a session tag of a session, the session having a duration in time and being associated with a context parameter. The method comprises monitoring the session. Monitoring the session comprises during the duration of the session identifying a plurality of information sources associated with the session. Monitoring the session comprises during the duration of the session acquiring information items from the plurality of information sources, the information items being associated with the context parameter. Monitoring the session comprises during the duration of the session linking the information items to the session and at least one of at least one other session, at least one other tagged or untagged information item, and at least one other session tag.

Advantageously this enables improved organization of information items of a session.

Advantageously this enables a non-linear way to organise information.

Advantageously this enables information items to be related to other relevant sources of information, thereby also enabling a more complete representation of the information items within a specific domain, which later can be experienced by users through personal and contextual filters.

According to a second aspect there is presented a method for retrieving information items of a session. The method is performed by a server. The method comprises acquiring a user query, the user query comprising at least a session tag of a session, the session having a duration in time and being associated with a context parameter. The method comprises retrieving at least one information item associated with the context parameter, the at least one information item being linked to at least one of at least one other session, at least one other tagged or untagged information item, and at least one other session tag.

Advantageously this enables improved retrieval of information items of a session.

Advantageously this enables a non-linear way to retrieve information.

Advantageously this enables retrieved information items to be related to other relevant sources of information, thereby also enabling a more complete representation of the information items within a specific domain, which can be experienced by users through personal and contextual filters during the retrieval.

According to a third aspect there is presented a server for organizing information items of a session. The server comprises a processing unit. The processing unit is arranged to acquire a session tag of a session, the session having a duration in time and being associated with a context parameter. The processing unit is arranged to monitor the session by during the duration of the session identify a plurality of information sources associated with the session. The processing unit is arranged to monitor the session by during the duration of the session acquire information items from the plurality of information sources, the information items being associated with the context parameter. The processing unit is arranged to monitor the session by during the duration of the session link the information items to the session and at least one of at least one other session, at least one other tagged or untagged information item, and at least one other session tag.

According to a fourth aspect there is presented a server for retrieving information items of a session. The server comprises a processing unit. The processing unit is arranged to acquire a user query, the user query comprising at least a session tag of a session, the session having a duration in time and being associated with a context parameter. The processing unit is arranged to retrieve at least one information item associated with the context parameter, the at least one information item being linked to at least one of at least one other session, at least one other tagged or untagged information item, and at least one other session tag.

According to a fifth aspect there is presented a computer program for organizing information items of a session, the computer program comprising computer program code which, when run on a server, causes the server to perform a method according to the first aspect.

According to a sixth aspect there is presented a computer program for retrieving information items of a session, the computer program comprising computer program code which, when run on a server, causes the server to perform a method according to the second aspect.

According to a seventh aspect there is presented a computer program product comprising a computer program according to at least one of the fifth aspect and the sixth aspect, and a computer readable means on which the computer program is stored.

It is to be noted that any feature of the first, second, third, fourth, fifth, sixth and seventh aspects may be applied to any other aspect, wherever appropriate. Likewise, any advantage of the first aspect may equally apply to the second, third, fourth, fifth, sixth, and/or seventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications system according to an embodiment;

FIGS. 2 and 3 are schematic diagrams showing functional modules of a server according to embodiments;

FIG. 4 shows one example of a computer program product comprising computer readable means according to an embodiment;

FIGS. 5, 6, 7, and 8 are flowcharts of methods according to embodiments; and

FIG. 9 schematically illustrates an information item according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

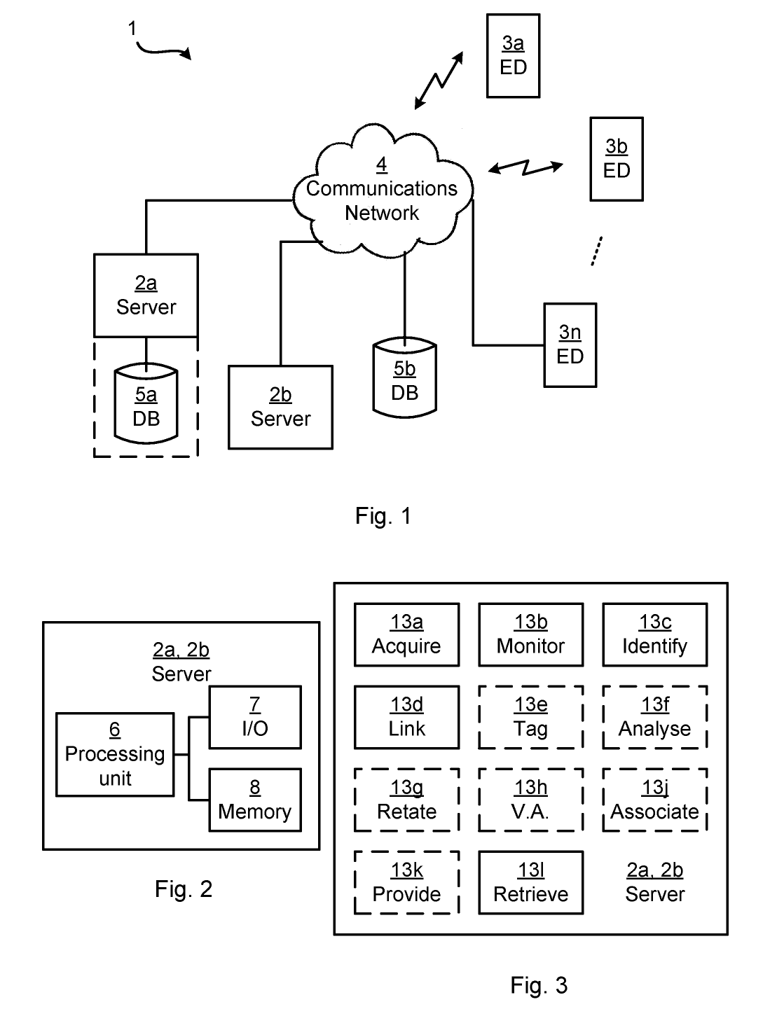

FIG. 1 is a schematic diagram illustrating a communications system 1 where embodiments presented herein can be applied. The communications system 1 comprises a plurality of electronic devices (ED) 3a, 3b, . . . , 3n. Each ED 3a-n acquires data. Such data will hereinafter be referred to as information items. Examples of different types of such information items will be provided below. The EDs 3a-n are examples of information sources. The EDs 3a-n are arranged to communicate via a communications network 4. The ED 3a-n may either have wireless access to the communications network 4 (as exemplified by ED 3a, 3b) or have wired access to the communications network 4 (as exemplified by ED 3n). The communications network 4 may thus be any combination of a wireless and wired communications network arranged to facilitate communications between the ED 3a-n.

The communications system 1 further comprises server 2a, 2b. The servers are also operatively connected to the communications network 4 and may therefore also be enabled to access to information items as acquired by the ED 3a-n. As noted above, each ED 3a-n acquires data. This data is stored by the servers 2a, 2b either internally or externally, such as in the databases 5a, 5b. As schematically illustrated in FIG. 1, the database with reference numeral 5a may be regarded as an internal database of the server 2a, whereas the database with reference numeral 5b may be regarded as an external database of the server 2a.

It is envisaged that the amount of data generated and acquired by various information sources in communications systems will increase. One issue that thus may arise in the communications system 1 is how to organize the information items as acquired by the ED 3a-n. Although there exists mechanisms for tagging information items (such as geo-tagging, where data is provided with a Global Positioning System, GPS, coordinate, and user tagging, where a user manually associates data with a tag), it may still be cumbersome to handle large amounts of information items in an efficient manner for purposes of organization and retrieval thereof.

Hence, one issue considered by the enclosed embodiments is how to efficiently gather information about topics being discussed and activities going on. Embodiments disclosed herein are based on a general concept of collecting and aggregating information across a number of connected devices and objects in order to enable flexible sessions, without loosing information about activities and/or instructions. Embodiments disclosed herein in particular relate to organizing information items of a session. In order to obtain organization of information items of a session there is provided a server, a method performed by the server, a computer program comprising code, for example in the form of a computer program product, that when run on a server, causes the server to perform the method. Embodiments disclosed herein further relate to retrieving information items. In order to obtain retrieval of information items there is provided a server, a method performed by the server, a computer program comprising code, for example in the form of a computer program product, that when run on a server, causes the server to perform the method.

FIG. 2 schematically illustrates, in terms of a number of functional modules, the components of a server 2a, 2b according to an embodiment. A processing unit 6 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 9a, 9b (as in FIG. 3), e.g. in the form of a memory 8. Thus the processing unit 6 is thereby arranged to execute methods as herein disclosed. The memory 6 may also comprise persistent storage, which, for example, can be any single one or combination of magnetic memory, optical memory, solid state memory or even remotely mounted memory. The server 2a, 2b may further comprise an input/output (I/O) interface 7 for receiving and providing information from other devices, such as (but not limited to) other servers 2a, 2b, databases 5a, 5b, and electronic devices 3a-n. The processing unit 6 controls the general operation of the server 2a, 2b, e.g. by sending control signals to the I/O interface 7, transmitting data and instructions to the memory 8, receiving reports and signals from the /O interface 7, and/or acquiring data and instructions from the memory 8. Other components, as well as the related functionality, of the server 2a, 2b are omitted in order not to obscure the concepts presented herein.

FIG. 3 schematically illustrates, in terms of a number of functional modules, the components of a server 2a, 2b according to an embodiment. The server 2a, 2b of FIG. 3 comprises a number of functional units; an acquiring unit 13a, a monitoring unit 13b, an identifying unit 13c,a linking unit 13d, and a retrieving unit 13l. The server 2a, 2b of FIG. 3 may further comprises a number of optional functional units, such as any of a tagging unit 13e, an analysing module 13f, a relating unit 13g, a voice analysis (V.A.) unit 13h, an associating unit 13j, and a providing unit 13k. The functionality of each functional unit 13a-l will be further disclosed below in the context of which the functional units may be used. In general terms, each functional unit 4a-f may be implemented in hardware or in software. The processing unit 6 may thus be arranged to from the memory 8 fetch instructions as provided by a functional unit 13a-l and to execute these instructions, thereby performing any steps as will be disclosed hereinafter.

A user of an electronic device 3a-n may interact with the method as performed by the server 2a, 2b by executing an application. This application may be provided by an application programming interface (API) which thus involves communicating with the server. Hence, a user may, by interacting with the application as executed by the electronic device 3a-n, be able to provide input to the method and retrieve output from the method, for example by sending a query to the server 2a, 2b.

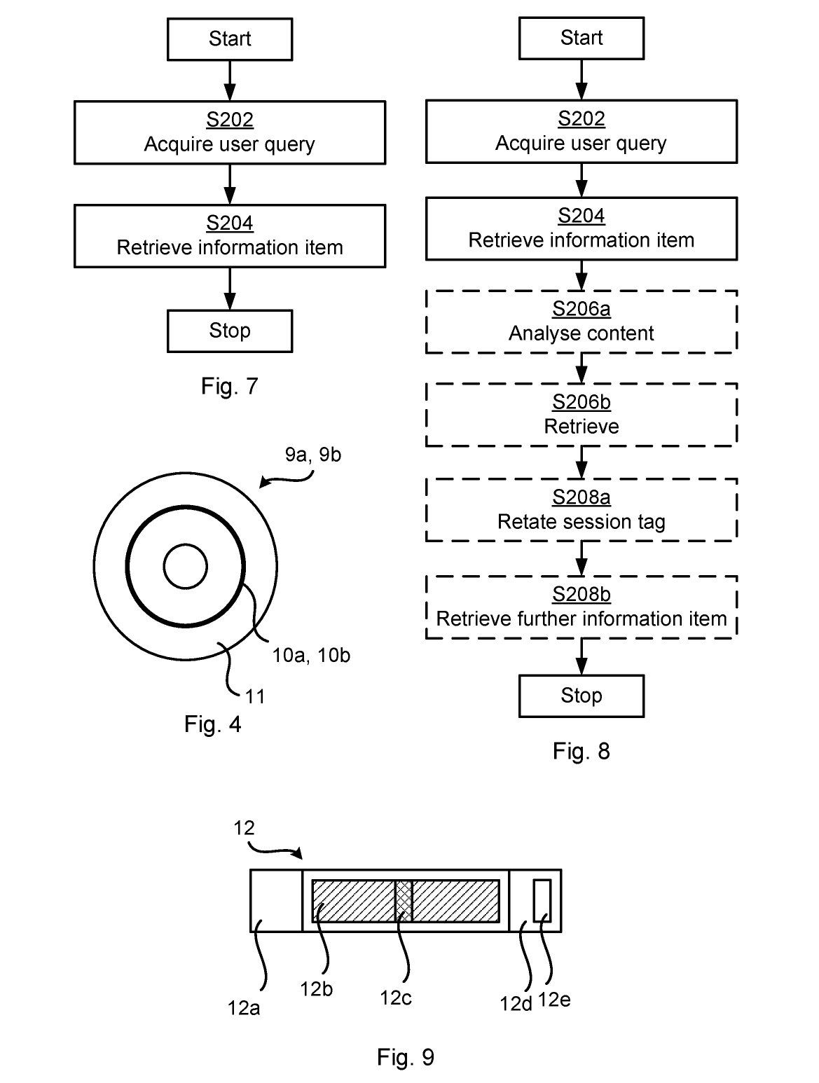

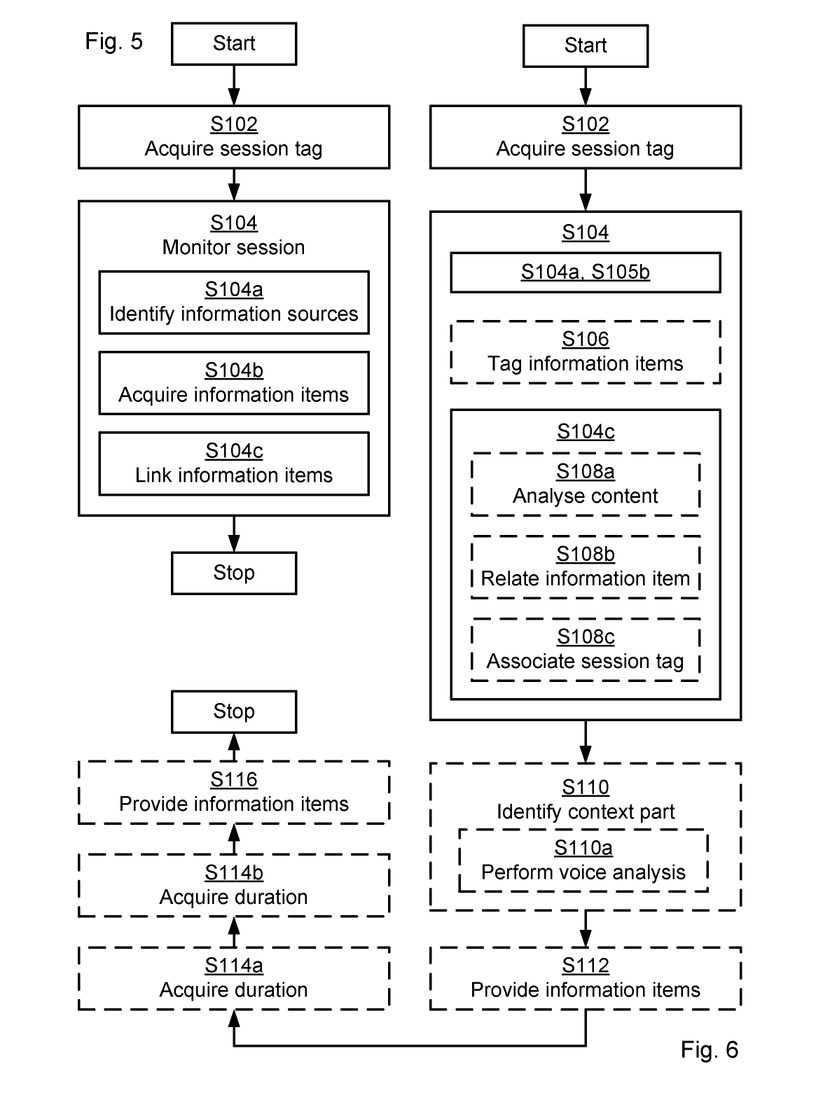

FIGS. 5 and 6 are flow charts illustrating embodiments of methods for organizing information items of a session. FIGS. 7 and 8 are flow charts illustrating embodiments of methods for retrieving information items of a session. The methods are performed by the server 2a, 2b. The methods are advantageously provided as computer programs 10a, 10b. FIG. 4 shows one example of a computer program product 9a, 9b comprising computer readable means 10. On this computer readable means 10, at least one computer program 10a, 10b can be stored, which at least one computer program 10a, 10b can cause the processing unit 6 and thereto operatively coupled entities and devices, such as the I/O interface 7 and the memory 8 to execute methods according to embodiments described herein. In the example of FIG. 4, the computer program product 9a, 9b is illustrated as an optical disc, such as a CD (compact disc) or a DVD (digital versatile disc) or a Blu-Ray disc. The computer program product could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the at least one computer program 10a, 10b is here schematically shown as a track on the depicted optical disk, the at least one computer program 10a, 10b can be stored in any way which is suitable for the computer program product 9a, 9b. The at least one computer program 10a, 10b and/or computer program product 9a, 9b may thus provide means for performing any steps as herein disclosed.

The embodiments disclosed herein are based on a general concept of first considering information items within a specific session. These information items may then be linked to other sessions, information items, etc. Each session has a duration in time. Further, each session is associated with a context parameter (i.e., a limitation in scope). By these two properties each session is well-defined. Further, each session is associated with a number of participants, or users, as represented by some of the information sources involved with the session. Other information sources involved with the session may represent sensors, databases, etc.

This enables selective linking (and optional tagging) of the information items of the session depending on the intended session context, any specified topics, historic data of the participants as organized during previous sessions, and so on. Within these boundaries the information items can be tied together in order to create a well organized and easy retrievable information items concerning all aspects of a session.

A method for organizing information items of a session thus comprises, in a step S102 as performed by the processing unit 6 of the server 2a, 2b, acquiring a session tag 12d of a session. The acquiring may be performed by executing functionality of the acquiring unit 13a. The computer program 9a, 9b and/or computer program product 10a, 10b may thus provide means for this acquiring. The session has a duration in time and is associated with a context parameter. Further details of the context parameter will be disclosed below. There may be different ways for the server 2a, 2b to acquire the session tag 12d. Different embodiments relating thereto will be disclosed below.

Based on the acquired session tag 12d the server 2a, 2b monitors the session. The server 2a, 2b is arranged to, in a step S104, monitor the session by performing a number of sub-routines, or sub-steps. The monitoring may be performed by executing functionality of the monitoring unit 13b. The computer program 9a, 9b and/or computer program product 10a, 10b may thus provide means for this monitoring. These sub-routines are thus performed during the session (as specified by the above mentioned duration in time). These sub-routines will be described in turn next. A first sub-routine concerns the information sources involved with the session. Particularly, the processing unit 6 of the server 2a, 2b is arranged to, in a step S104a identify a plurality of information sources 3a, 3b, 3n associated with the session. The identifying may be performed by executing functionality of the identifying unit 13c. The computer program 9a, 9b and/or computer program product 10a, 10b may thus provide means for this identifying. Thereby the server 2a, 2b knows which information sources 3a, 3b, 3n to monitor during the session. Each information sources 3a, 3b, 3n may transmit any number of information items 12 during the session. These information items 12 may be acquired by the server 2a, 2b. Particularly, those information items 12 associated with the context parameter are to be acquired by the server 2a, 2b. Hence, the processing unit 6 of the server 2a, 2b is arranged to, in a step S104b, acquire information items 12 from the plurality of information sources 3a, 3b, 3n where the information items are associated with the context parameter. The acquiring may be performed by executing functionality of the acquiring unit 13a. The computer program 9a, 9b and/or computer program product 10a, 10b may thus provide means for this acquiring. Once the information items 12 have been acquired they are associated with the session. This association is accomplished through linking. The processing unit 6 of the server 2a, 2b is therefore arranged to, in a step S104c, link the acquired information items 12 to the session. The acquired information items 12 are in step S104c further linked to at least one other session, at least one other tagged or untagged information item, and/or at least one other session tag. The linking may be performed by executing functionality of the linking unit 13d. The computer program 9a, 9b and/or computer program product 10a, 10b may thus provide means for this linking.

Hence, the disclosed method for organizing information items of a session enables the server 2a, 2b to identify the different electronic devices involved in the session (i.e., devices as represented by the information sources 3a, 3b, 3n) and their activities (i.e., information items 12 as transmitted by the information sources 3a, 3b, 3n during the session). By considering the context parameter the server 2a, 2b is further enabled to determine a relationship between the activities (i.e., between the information items 12).

FIG. 9 schematically illustrates an information item 12 according to embodiments. As schematically illustrated the information item 12 may have a number of fields. For example, the information item 12 may have an identity information field 12a providing an identification of the electronic device by which the information item 12 was acquired. For example, the information item 12 may have a data stream field comprising a data stream 12b. For example, the information item 12 may have a context part 12C. For example, the information item 12 may have an event tag field 12d. For example, the information item 12 may have a context tag field 12e. These fields will be further disclosed below.

The plurality of information sources may be electronic devices. The electronic devices may be any combination of user equipment, smart-boards, sensors, and other servers. Each information item may be provided by a data stream 12b representing a text message, an audio segment, a video segment, an electronic document, a sensor measurement, or Internet web page content.

The step S104 of monitoring the session enables sessions and information items to be continuously tagged. Examples of sessions and information items that could be continuously tagged include, but are not limited to, are: identification of any user being active (on audio or video, where the audio or vide represent the information item being monitored during the session), topics discussed during the session, point in time of different events within the session, identification of electronic device used during the session, information items as defined by content of digital objects or presentations, information items as defined by video or web sites being displayed during the session, sensor readings registered during the session, and locations related to the session, information items, and/or information sources.

Different embodiments relating to these and other aspects will now be described.

According to one embodiment the database 5a is a graph database and is arranged to store the linked tagged information items. Graph databases may be regarded as handling structural database changes very well. According to one embodiment the graph database is arranged to store a plurality of linked tagged information items from which information items are retrievable. As will be further disclosed below, information items may be retrieved from the database 5a during a user query. For example, within the area of graph theory, graph centrality measurements could be used to find the shortest path between two elements (such as between two information items) stored in the graph database.

According to one embodiment the session tag is provided as part of a uniform resource identifier (URI). Thus the information items may, during sessions, be regarded as URI:s with meta data attached to them. Hence, the disclosed method for organizing information items of a session may be regarded as providing meta tagging of event-related objects, where the event corresponds to the session and where the objects are defined by the information items. Further, the acquired information items may be tagged with the session tag. Thereby the information items may be regarded as tagged with a URI. Particularly, according to one embodiment the processing unit 6 of the server 2a, 2b is arranged to, in an optional step S106, tag the acquired information items with the session tag so as to generate tagged information items. The tagging may be performed by executing functionality of the tagging unit 13a. The computer program 9a, 9b and/or computer program product 10a, 10b may thus provide means for this tagging. In this way it may be straightforward to address the storage locations of the information items as well as related online resources. Further, the information items may be provided in uniform data format. This may simplify organization as well as retrieval of the acquired information items. Therefore, according to one embodiment the processing unit 6 of the server 2a, 2b is arranged to, in an optional step S112, provide the acquired information items in a uniform data format. The providing may be performed by executing functionality of the providing unit 13a. The computer program 9a, 9b and/or computer program product 10a, 10b may thus provide means for this providing.

As disclosed in step S104 the server 2a, 2b performs monitoring of the session. This monitoring process may be regarded as a cloud service that, for example, resides in one of the central server nodes of a communications system. By performing the monitoring as in step S104 the server 2a, 2b structures and aggregates the sessions. During this process, the server 2a, 2b may utilize information from other available sources in order to obtain an interpretation, or analysis, of the information items of the session. This may enable the server 2a, 2b, for example, to give additional examples and suggestions of related knowledge. When applicable, the server 2a, 2b also relates the information items of a particular session to previous sessions (based on the information sources of the session, the context parameter, session tags, context tag, etc.). The thus aggregated information is finally organized and stored by the server 2a, 2b so that it can be accessed after the session.

Thus, according to one embodiment the processing unit 6 of the server 2a, 2b is arranged to, in an optional step S108c, associate the session tag of at least one of the acquired information items with a weighting factor. The associating may be performed by executing functionality of the associating unit 13j. The computer program 9a, 9b and/or computer program product 10a, 10b may thus provide means for this associating. The step of linking (as in step S104c) may then be dependent on the weighting factor. The weighting factor may thereby be used to enabled different degrees of linking between information items, etc. instead of allowing a single degree of linking (i.e., where to elements either are linked or not linked). The weighting factor may thus be regarded as filter, enabling or disabling linking of information items of the session to different information sources (sensors, web content, etc.) and personal profiles.

There may be different ways to associate the session with the duration in time and the context parameter. For example, the duration in time and context parameter may be determined from user input. Particularly, according to one embodiment the processing unit 6 of the server 2a, 2b is arranged to, in an optional step S1114a, acquire the duration in time and the context parameter of the session from user input. The acquiring may be performed by executing functionality of the acquiring unit 13a. The computer program 9a, 9b and/or computer program product 10a, 10b may thus provide means for this acquiring. Hence, according to this embodiment, a user specifies the duration in time and the context parameter of the session. In order to do so, one of the EDs 3a-n or the server 2a, 2b may be provided with a user interface arranged to receive such user input. If the user input is received by an ED 3a-n the ED 3a-n may be arranged to transmit this user input to the server 2a, 2b for the server to be able to monitor the session. For example, the duration in time and context parameter may be determined according to other criteria. One such criteria could be an electronic calendar item. Thus, according to one embodiment the processing unit 6 of the server 2a, 2b is arranged to, in an optional step S114b, acquire the duration in time and the context parameter of the session from an electronic calendar item. The acquiring may be performed by executing functionality of the acquiring unit 13a. The computer program 9a, 9b and/or computer program product 10a, 10b may thus provide means for this acquiring. As is known in the art, an electronic calendar item has a starting time and an ending time. Hence the duration in time of the session may correspond to the time from the starting time to the ending time of the electronic calendar item. As is known in the art, an electronic calendar item has a subject. Hence the context parameter of the session may correspond to the subject of the electronic calendar item.

There may be different ways to relate, link, and/or connect the information items to other the information items, etc. One way of doing so is to analyse content of tagged information items of the session. Hence according to one embodiment the processing unit 6 of the server 2a, 2b is arranged to, in an optional step S108a, analyse content of tagged information items of the session. The analysing may be performed by executing functionality of the analysing unit 13f. The computer program 9a, 9b and/or computer program product 10a, 10b may thus provide means for this analysing. The processing unit 6 of the server 2a, 2b is then arranged to, in an optional step S108b, based on the analysis relate tagged information items of the session to at least one other session, tagged information items of at least one other session, and/or at least one other session tag. The relating may be performed by executing functionality of the relating unit 13g. The computer program 9a, 9b and/or computer program product 10a, 10b may thus provide means for this relating. Thereby the tagged information items of the session may be related, linked, and/or connected to previous sessions, learned knowledge, Internet resources, etc. These steps may be performed by content aware filtering of the tagged information items of the session.

Any tagging may depend on an intended context of the session. The intended context may be explicitly provided, such as by the context parameter. The intended context may be implicitly present. In this case a content analysis of tagged information items of the session, such as outlined in step S108a, may be performed in order to determine the intended context. According to one embodiment the processing unit 6 of the server 2a, 2b is arranged to, in an optional step S110, identify at least one context part 12C in at least one of the acquired information items. The identifying may be performed by executing functionality of the identifying unit 13c. The computer program 9a, 9b and/or computer program product 10a, 10b may thus provide means for this identifying. This at least one context part 12C may represent the intended context of the session. The processing unit 6 of the server 2a, 2b is then arranged to, in an optional step, tag the at least one context part with a context tag 12e representing a context of the at least one context part. The tagging may be performed by executing functionality of the tagging unit 13e. The computer program 9a, 9b and/or computer program product 10a, 10b may thus provide means for this tagging. This context may be the intended context of the session, or it may be a sub-context of the session. More particularly, according to one embodiment the context tag represents at least one of identity of the information source of the at least one context part, a point in time for acquiring the at least one context part, and identification of content of the at least one context part. In a case the at least one information item is provided by a data stream 12b representing an audio segment, the identifying may comprise, in an optional step S110a, performing voice analysis of the audio segment to identify said at least one context part. The voice analysis may be performed by executing functionality of the voice analysis unit 13h. The computer program 9a, 9b and/or computer program product 10a, 10b may thus provide means for this voice analysis. Voice analysis and different applications thereof are as such known in the art. The linking as performed in step S104c may be based on the context tag.

By means of the linking, information items may be aggregated topic-wise. This hence enables a user to re-experience sessions topic-wise. One way of enabling a user to explore the aggregated information items is, for example, to provide linked information items to a user according to their occurrence in time. One way of enabling a user to explore the aggregated information items is, for example, to provide linked information items to a user individually adapted for a particular user, thus resulting in a personalized view of the information items for this particular user. This may be achieved by linking information items of a session to an information source, linking the information source to a particular user (thus linking the information items to the particular user), and linking the session to at least one other session (or by linking at least one information item of the session to one of at least one other session, at least one other tagged or untagged information item, and at least one other session tag, where the at least one other session, the at least one other tagged or untagged information item, and the at least one other session tag are also associated with the particular user).

The thus organized information items of the session may be queried by a user. Hence there is provided a method for retrieving information items of a session. The method is performed by a server 2a, 2b. The method comprises, in a step S202 as performed by the processing unit 6 of the server 2a, 2b, acquiring a user query. The acquiring may be performed by executing functionality of the acquiring unit 13a. The computer program 9a, 9b and/or computer program product 10a, 10b may thus provide means for this acquiring. The user query comprises at least a session tag of a session. As disclosed above, the session has a duration in time and is associated with a context parameter. Based on the session tag as comprised in the user query the server 2a, 2b is able to identify information items. Particularly, the processing unit 6 of the server 2a, 2b is arranged to, in a step S204, retrieve at least one information item associated with the context parameter (as associated with the session tag). The retrieving may be performed by executing functionality of the retrieving unit 13l. The computer program 9a, 9b and/or computer program product 10a, 10b may thus provide means for this retrieving. The at least one information item is linked to at least one other session, at least one other tagged or untagged information item, and/or at least one other session tag.

According to one embodiment the user query further comprises identity information of at least one of a user account and an electronic device. The step S204 of retrieving the at least one information item may then be based on the identity information. This may enable personalized (i.e., user specific) information retrieval.

As noted above, the method for organizing information items of a session according to one embodiment comprises relating tagged information items of the session to at least one other session, tagged information items of at least one other session, and/or at least one other session tag based on analysing content of tagged information items of the session (as in steps S108a-S108b) during the session. This may be utilized also during retrieval of information items of the session. Hence, according to embodiment the processing unit 6 of the server 2a, 2b is arranged to, in an optional step S206a, analyse content of at least one information item tagged with the session tag; and, in an optional step S206b, retrieve, based on the analysis, at least one other session, tagged information items of the at least one other session, and/or at least one other session tag. The analysing may be performed by executing functionality of the analysing unit 13f. The computer program 9a, 9b and/or computer program product 10a, 10b may thus provide means for this analysing. The retrieving may be performed by executing functionality of the retrieving unit 13l. The computer program 9a, 9b and/or computer program product 10a, 10b may thus provide means for this retrieving.

As noted above, the method for organizing information items of a session according to one embodiment comprises identifying at least one context part 12C in at least one of the acquired information items and tagging the at least one context part with a context tag 12e representing a context of the at least one context part (as in step S110) during the session. This may be utilized also during retrieval of information items of the session. Hence, according to embodiment the processing unit 6 of the server 2a, 2b is arranged to, in an optional step S208, relate the session tag to a context tag 12e representing a context of at least one context part 12C in at least one information item; and, in an optional step S204a, retrieve at least one further information item tagged with the context tag. Hence, this may enable a user to retrieve not only one information item but also information linked to the retrieved information item. The relating may be performed by executing functionality of the relating unit 13g. The computer program 9a, 9b and/or computer program product 10a, 10b may thus provide means for this relating. The retrieving may be performed by executing functionality of the retrieving unit 13l. The computer program 9a, 9b and/or computer program product 10a, 10b may thus provide means for this retrieving.

### Representative Scenarios

Two scenarios exemplifying the herein disclosed embodiments will be disclosed next.

### Scenario 1: Meeting Session

A first scenario relates to a session corresponding to a meeting situation, where participants of the meeting have electronic devices 3a-n which during the meeting may transmit/receiver/acquire/use data corresponding to information items. Hence, each participant may to the meeting bring a number of electronic devices with communications capabilities, each electronic device possibly containing different material, such as pictures, videos, documents, and presentations, representing information items which thus have the possibility to be associated with the session.

Once the meeting is about to begin, one of the meeting participants starts a new session by providing user input to her electronic device. The meeting participant specifies the topic of the meeting and identities of the meeting participants as context parameters for the session. The user input may, for example, be provided by speech, as text, or automatically based on an electronic calendar item (as in any of steps S114a, S114b).

During the meeting, i.e., during the duration of the session, the session is monitored (as in step S104) and all events of the electronic devices (such as speech, presentation material, videos, notes, sketches, web searches and browsing, etc.) are selectively tagged (as in any of steps S106, S110) based on the meeting topic and aggregated topic-wise by the server 2a, 2b executing any steps as disclosed above necessary to perform these actions.

During the meeting the server 2a, 2b also accesses a range of internal and online resources to complement the information items that origins from the session and that are acquired by the server 2a, 2b (as in any of steps S104c, S108a, S108b). This complement information may be provided by means of at least one of at least one other session, at least one other tagged or untagged information item, and at least one other session tag. Hence, the information items of the session are linked to not only the session itself but also at least one of at least one other session, at least one other tagged or untagged information item, and at least one other session tag. For example, assuming that two participants previously taken part in at least one meeting (as registered by a respective session) with a similar topic, or where similar information items have been acquired by the server 2a, 2b, the server 2a, 2b during the present session also aggregates information items across all of these sessions, etc.

After the meeting, all participants are by querying the server 2a, 2b (as in step S202) enabled to re-experience the session in a flexible way, including reviewing presentations, sketches, video clips, etc. as retrieved by the server 2a, 2b (as in step S204). The participants may also explore the topics of the session including related knowledge and information items since the retrieved information items are linked to at least one of at least one other session, at least one other tagged or untagged information item, and at least one other session tag (as in any of steps S206a, S206b, S208, S204a). By including also identity information of the participant (i.e. the user), the topics may be explored based on their personal profile, thus enabling focus on the topics that are related to a particular participant.

### Scenario 2: Surveying Session

A second scenario relates to a session corresponding to a surveying situation.

During surveying of a rural area a plurality of electronic devices with communications capabilities, such as tablet computers, temperature sensors, and other objects, such as magnifying glasses, water containers, soil, may be used.

Once the surveying is about to begin, one of the participants taking part in the surveying starts a new session by providing user input to her electronic device. The participant specifies the topic of the meeting and identities of the participants as context parameters for the session. The user input may, for example, be provided by speech, as text, or automatically based on an electronic calendar item (as in any of steps S114a, S114b).

During the surveying, i.e., during the duration of the session, the session is monitored (as in step S104) and all events of the electronic devices (such as speech, measurement values from sensors, videos, notes, sketches, web searches and browsing, etc.) are selectively tagged (as in any of steps S106, S110) based on the topic of the surveying and aggregated topic-wise by the server 2a, 2b executing any steps as disclosed above necessary to perform these actions. In this case, information from surveying of another area can be used to complement the final results of the surveying. This complement information may be provided by means of at least one of at least one other session, at least one other tagged or untagged information item, and at least one other session tag (as in any of steps S104c, S108a, S108b). Hence, the information items of the session are linked to not only the session itself but also at least one of at least one other session, at least one other tagged or untagged information item, and at least one other session tag.

One participant taking part in the surveying may thus in situ (i.e., during the duration of the session) query the server 2a, 2b (as in step S202) in order to retrieve further information items linked to the session (as in step S204). The retrieved information items may, for example, provide additional information about recommended soil moisture levels. The retrieved information items may thus be used for a direct comparison to current measurements and thereby providing an increased understanding of the on-going surveying.

Although each participant collects individual data during the session (and possibly by taking part in another session) all events are, by the linking (as in step S104c), aggregated into one representation. Thus, in case, the electronic devices have different capabilities the registered information can be used complement each other.

After the surveying, all participants are by querying the server 2a, 2b (as in step S202) enabled to re-experience the surveying in a flexible way, including reviewing presentations, sketches, video clips, measurements from sensors, etc. as retrieved by the server 2a, 2b (as in step S204). The participants may also explore the topics of the session including related knowledge and information items since the retrieved information items are linked to at least one of at least one other session, at least one other tagged or untagged information item, and at least one other session tag (as in any of steps S206a, S206b, S208, S204a). By including also identity information of the participant (i.e. the user), the topics may be explored based on their personal profile, thus enabling focus on the topics that are related to a particular participant. This may enable a better understanding of the results of the surveying.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for organizing information items of a session, the method comprising:
performing by a server the operations of:
acquiring a session tag of a session, the session having a duration in time and being associated with a context parameter; and
monitoring the session, by during the duration of the session:
identifying a plurality of information sources associated with the session;
acquiring information items from the plurality of information sources, the information items being associated with said context parameter; and
linking the information items to the session and at least one of at least one other session, at least one other tagged or untagged information item, and at least one other session tag.

2. The method according to claim 1, further comprising the operations of:
tagging the acquired information items with the session tag so as to generate tagged information items.

3. The method according to claim 2, wherein linking comprises:
analysing content of tagged information items of the session; and
relating, based on the analysis, said tagged information items of the session to at least one of said at least one other session, tagged information items of said at least one other session, and at least one other session tag.

4. The method according to claim 1, further comprising the operations of:
identifying at least one context part in at least one of the acquired information items and tagging the at least one context part with a context tag representing a context of the at least one context part.

5. The method according to claim 4, wherein the context tag represents at least one of identity of the information source of the at least one context part, a point in time for acquiring the at least one context part, and identification of content of the at least one context part.

6. The method according to claim 4, wherein at least one information item is provided by a data stream representing an audio segment, the identifying further comprising:
performing voice analysis of the audio segment to identify said at least one context part.

7. The method according to claim 4, wherein the linking is based on the context tag.

8. The method according to claim 1, wherein linking comprises:
associating the session tag of at least one of said acquired information items with a weighting factor, and wherein said linking is dependent on said weighting factor.

9. The method according to claim 1, further comprising the operations of:
providing the acquired information items in a uniform data format.

10. The method according to claim 1, further comprising the operations of:
acquiring the duration in time and the context parameter of the session from user input.

11. The method according to claim 1, further comprising the operations of:
acquiring the duration in time and the context parameter of the session from an electronic calendar item.

12. The method according to claim 1, wherein the session tag is provided as part of a uniform resource identifier, URI.

13. The method according to claim 1, wherein the plurality of information sources are electronic devices, the electronic devices being any combination of user equipment, smart-boards, sensors, and other servers.

14. The method according to claim 1, wherein each information item is provided by a data stream representing a text message, an audio segment, a video segment, an electronic document, a sensor measurement, or Internet web page content.

15. A method for retrieving information items of a session, the method comprising:
performing by a server the operations of:
acquiring a user query, the user query comprising at least a session tag of a session, the session having a duration in time and being associated with a context parameter; and
retrieving at least one information item associated with said context parameter, the at least one information item being linked to at least one of at least one other session, at least one other tagged or untagged information item, and at least one other session tag.

16. The method according to claim 15, wherein the user query further comprises identity information of at least one of a user account and an electronic device, and wherein retrieving said at least one information item is based on said identity information.

17. The method according to claim 15, further comprising the operations of:
analysing content of at least one information item tagged with the session tag; and
retrieving, based on the analysis, at least one of at least one other session, tagged information items of said at least one other session, and at least one other session tag.

18. The method according to claim 15, further comprising the operations of:
relating the session tag to at least one context tag representing a context of at least one context part in at least one information item; and
retrieving at least one further information item tagged with the context tag.

19. A server for organizing information items of a session, the server comprising:
a processor configured to acquire a session tag of a session, the session having a duration in time and being associated with a context parameter;
the processor being further configured to monitor the session, by during the duration of the session:
identify a plurality of information sources associated with the session;
acquire information items from the plurality of information sources, the information items being associated with said context parameter; and
link the information items to the session and at least one of at least one other session, at least one other tagged or untagged information item, and at least one other session tag.

20. The server according to claim 19, further comprising:
a graph database arranged to store the linked tagged information items.

21. A server for retrieving information items of a session, the server comprising:
a processor configured to acquire a user query, the user query comprising at least a session tag of a session, the session having a duration in time and being associated with a context parameter; and
the processor being further configured to retrieve at least one information item associated with said context parameter, the at least one information item being linked to at least one of at least one other session, at least one other tagged or untagged information item, and at least one other session tag.

22. The server according to claim 21, further comprising:
a graph database arranged to store a plurality of linked tagged information items from which said at least one information item is retrieved.

23. A computer program product for organizing information items of a session, the computer program product comprising a non-transitory computer readable medium storing computer program code which, when run on a server, causes the server to:
acquire a session tag of a session, the session having a duration in time and being associated with a context parameter; and
monitor the session by, during the duration of the session:
identify a plurality of information sources associated with the session;
acquire information items from the plurality of information sources, the information items being associated with said context parameter; and
linking the information items to the session and at least one of at least one other session, at least one other tagged or untagged information item, and at least one other session tag.

24. A computer program product for retrieving information items of a session, the computer program product comprising a non-transitory computer readable medium storing computer program code which, when run on a server, causes the server to:
acquire a user query, the user query comprising at least a session tag of a session, the session having a duration in time and being associated with a context parameter; and
retrieve at least one information item associated with said context parameter, the at least one information item being linked to at least one of at least one other session, at least one other tagged or untagged information item, and at least one other session tag.

25. (canceled)
